(19) United States
(12) Patent Application Publication
(10) Pub. No.: US 2010/0024327 A1
(43) Pub. Date: Feb. 4, 2010

(54) METHOD OF MANUFACTURING A STEPPED RISER, AN ELEMENT FOR FORMING INTO A STEPPED RISER AND A STEPPED RISER AND A MEMBER FOR CHANGING THE MECHANICAL DYNAMIC PERFORMANCE OF A STEPPED RISER

(75) Inventor: Stephen John Kennedy, Ottawa (CA)

Correspondence Address: NIXON & VANDERHYE, PC, 901 NORTH GLEBE ROAD, 11TH FLOOR, ARLINGTON, VA, 22203, US

(73) Assignee: INTELLIGENT ENGINEERING (BAHAMAS) LIMITED, Nassau (BS)

(21) Appl. No.: 12/444,667

(22) PCT Filed: Oct. 12, 2007
(86) PCT No.: PCT/GB2007/003889

§ 371 Date: Jun. 17, 2009

(30) Foreign Application Priority Data
Oct. 16, 2006 (GB) 0620499.4

(51) Int. Cl. E04F 11/09; C09J 5/04; B32B 9/04

(52) U.S. Cl. 52/182; 156/221; 428/411.1

(57) ABSTRACT

A method of manufacturing a stepped riser comprising providing a first sheet of metal with a layer of plastics or polymer material bonded to the metal with at least one indentation formed in the layer of plastics or polymer material thereby to allow bending of the sheet of metal along pre-determined lines substantially without inducing compression or tension through the thickness of the layer of plastics or polymer material.

The present invention relates to stepped risers, particularly seating risers for sports stadia and other entertainment venues. The invention in particular involves a new method of manufacturing a stepped riser and an element for forming into a stepped riser.

To increase the revenue from sporting and other events, it is desirable to maximize the number of spectators that can be accommodated in a sports stadium or other venue. To do this it is necessary to provide additional tiers of seats, often resulting in structures in which a significant portion of the upper bowl seating cantilevers over other parts of the structure. Accordingly, the weight of risers supporting such seating should be minimized to reduce the size and cost of the supporting structure. To reduce transient and resonant vibrations associated with sporting and entertainment events the risers must be stiff, have sufficient mass, or be constructed with materials having good damping characteristics.

Existing designs of seating risers are made of prestressed or precast concrete or steel. Known riser sections are generally constructed from concrete as it allows for long clear spans between rakers (typically 12,200 mm) with reasonable vibration control as concrete has a damping coefficient of 0.2, good fire resistance and relatively low maintenance cost. The major disadvantage of concrete construction is that the riser section is heavy, e.g. about 10 T for a two tier riser, with self weight (deadload) equal to the design superimposed live load due to use and occupancy. It is therefore necessary to provide heavier, stronger, stiffer and more costly superstructure and foundations to support the riser sections, especially for large cantilever seating sections.

To minimise self weight, and hence reduce the cost of the superstructure and foundations, the riser sections may be constructed with folded steel plates that are supported by intermediate rakers and a secondary steel framework. Typically the maximum span for this type of construction is approximately 6100 mm and the self weight about 40% of an equivalent concrete structure. However, steel risers are more susceptible to sound and vibration problems, having a damping coefficient of 0.1, and have additional costs associated with the fabrication and erection of the intermediate rakers and secondary steel framework.

GB 2,368,041 discloses a stepped riser comprising a sandwich structure having upper and lower metal plates and an intermediate layer of plastics or polymer materials bonded to the metal plates so as to transfer shear forces therebetween. The plates are pre bent into the desired stepped riser shape and welded together and then the intermediate layer is injected into the stepped riser shaped cavity between the two plates. The sandwich structure plates used in forming the stepped riser have increased stiffness as compared to steel plates of comparable thickness and avoid or reduce the need to provide stiffening elements. This results in a considerably simpler structure with fewer welds or none leading to both simplified manufacture and a reduction in the area vulnerable to fatigue or corrosion. Further details of sandwich plate structures suitable for use in the risers of GB 2,368,041 can be found in U.S. Pat. No. 5,778,813 and British Patent Application GB-A-2 337 022. The intermediate layer may also be a composite core as described in GB 2,355,957.

The present invention provides a method of manufacturing a stepped riser, said method comprising:

providing a first sheet of metal;

bonding a layer of plastics or polymer material to said first sheet of metal; and

after said bonding, bending said sheet of metal along at least one predetermined line to form at least one run portion and at least one rise portion.

In this way, no welding is needed prior to applying the plastics or polymer layer. Preferably the sheet of metal is prepared by rolling prior to bonding. Thus stepped risers of any width can be prepared.

According to the present invention, there is further provided a method of manufacturing a stepped riser, said method comprising: providing a first sheet of metal; preparing for the bonding of a layer of plastics or polymer material to said sheet of metal so that said layer has at least one indentation thereby to allow, after bonding, bending of said sheet of metal along at least one pre-determined line substantially without inducing compression and/or tension through the thickness of said layer of plastics or polymer material.

In this way the manufacturing process is simplified because the first sheet of metal can be transported as a flat sheet, even once the layer of plastics or polymer material has bonded to that sheet of metal. This reduces the cost of transport of the components necessary for assembling a stepped riser to the site because, contrary to what is disclosed in GB 2,368,041 the sheet can be transported flat rather than in the form of a stepped riser irrespective of whether or not the layer of plastics or polymer material is bonded onto the sheet of metal on site or not. This is because the plastics or polymer material in the present invention is bonded to the sheet of metal whilst the sheet of metal is in the flat state. This is arranged for by ensuring that after bonding the layer of plastics or polymer material has at least one indentation so that bending of the sheet along at least one predetermined line can be performed substantially without inducing compression and/or tension through the thickness of the layer of plastics or polymer material.

The present invention also provides an element for forming into a stepped riser, said element comprising a sheet of metal and a layer of plastics or polymer material bonded to said sheet of metal, said layer comprising at least one indentation thereby to allow bending of said sheet of metal along at least one pre-determined line substantially without inducing compression and/or tension through the thickness of said layer.

This element can be transported to the assembly site in the flat state and bent on site to form a stepped riser. An advantage of the present application is that no welding is necessary before the plastics or polymer material is cast. The sheet of metal can be shaped by rolling and the width of the final stepped riser therefore has no physical limitation.

The present invention also relates to a stepped riser comprising an above element wherein the element is bent along the at least one pre-determined line to form at least one run portion and at least one rise portion.

It is important to control the dynamic mechanical frequency of stepped risers because of the likelihood of people moving on the risers in unison. A typical target design frequency of 7.5 Hz exists for an unloaded structure which will reduce to about 6 Hz when the structure is loaded.

The present invention provides a member for changing the mechanical dynamic performance of a stepped riser, said member comprising a sheet of material with longitudinal edge portions which are portions of each longitudinal edge bent to one side of said sheet, one of said longitudinal edge portions being longer than the other.

This member can be attached to riser portions of a stepped riser on either side of a run portion and can therefore influence the dynamic mechanical frequency of the stepped riser.

The materials, dimensions and general properties of the sheets of metal and layer of polymer or plastics material of the invention may be chosen as desired for the particular use to which the stepped riser is to be put and in general may be as described in U.S. Pat. No. 5,778,813 and U.S. Pat. No. 6,050,208. Steel or stainless steel is commonly used in thicknesses of 0.5 to 20 mm and aluminium may be used where light weight is desirable. Similarly, the plastics or polymer core is preferably compact (i.e. not foamed) and may be any suitable material, for example an elastomer such as polyurethane, as described in U.S. Pat. No. 5,778,813 and U.S. Pat. No. 6,050,208. Lightweight forms or inserts may also be included as described in WO 01/32414. The first sheet of metal may be painted or have a different surface treatment applied to improve traction.

A riser according to the present invention can be designed to meet relevant serviceability criteria and construction constraints related to vibration and deflection control, and plate handling. The resulting structure is light, stiff and, with the plastics or polymer material's inherent dampening characteristics, provides improved structural and vibration response performance over risers built with stiffened steel plates and rolled sections (secondary steel work) or those built with prestressed concrete.

The present invention will be described further below with reference to the following description of an exemplary embodiment and the accompanying schematic drawings, in which:

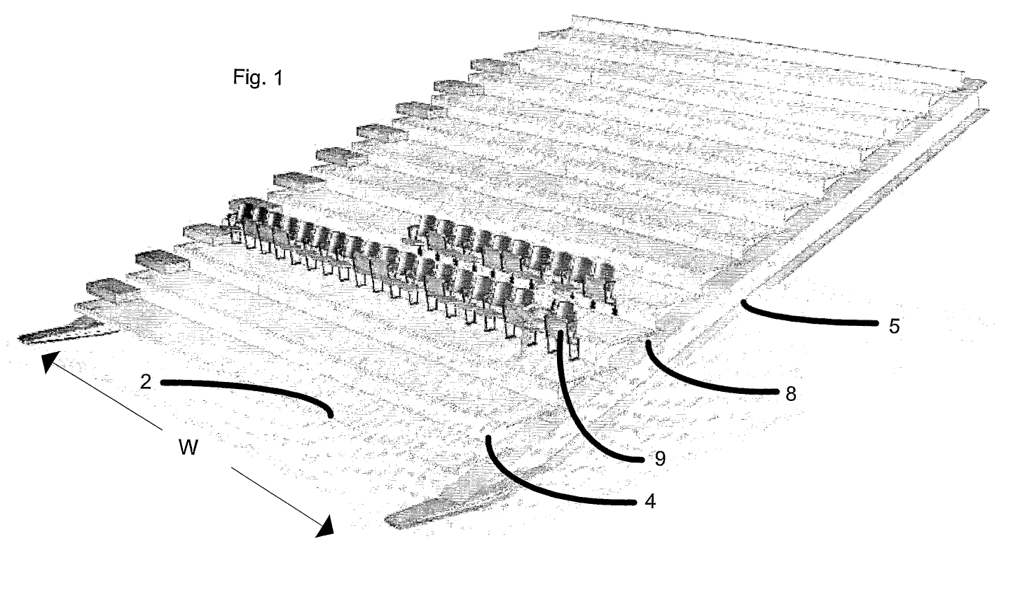

FIG. 1 is a perspective view of a riser according to the present invention;

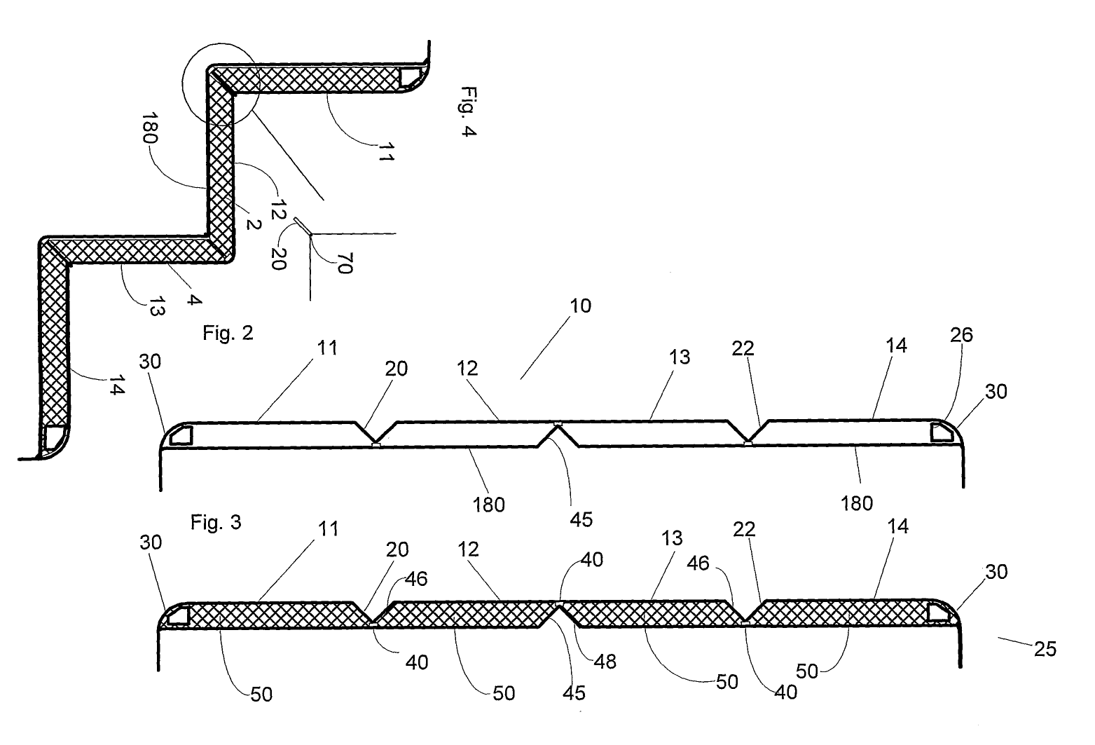

FIG. 2 is a cross-sectional view of a first sheet of metal according to the present invention;

FIG. 3 is a cross-sectional view of an element comprising the first sheet of metal of FIG. 2 after bonding of a layer of plastics or polymer material onto the sheet of metal;

FIG. 4 is a cross-sectional view of the element of FIG. 3 after bending to form a stepped riser;

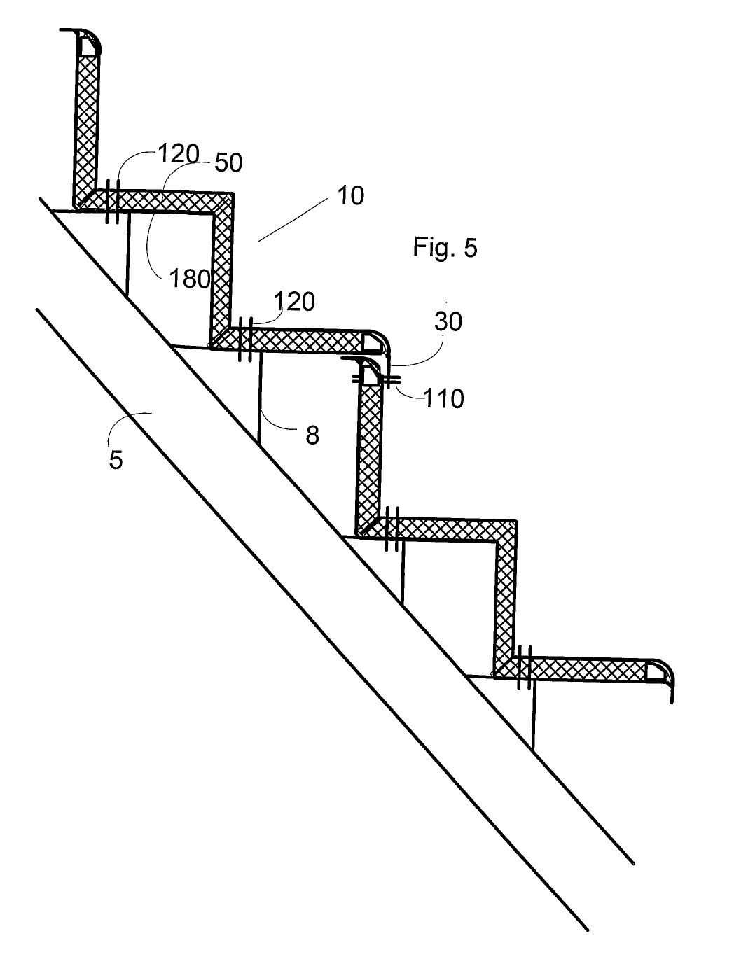

FIG. 5 illustrates, in cross-section, the assembly of a stepped riser using two elements of FIG. 4;

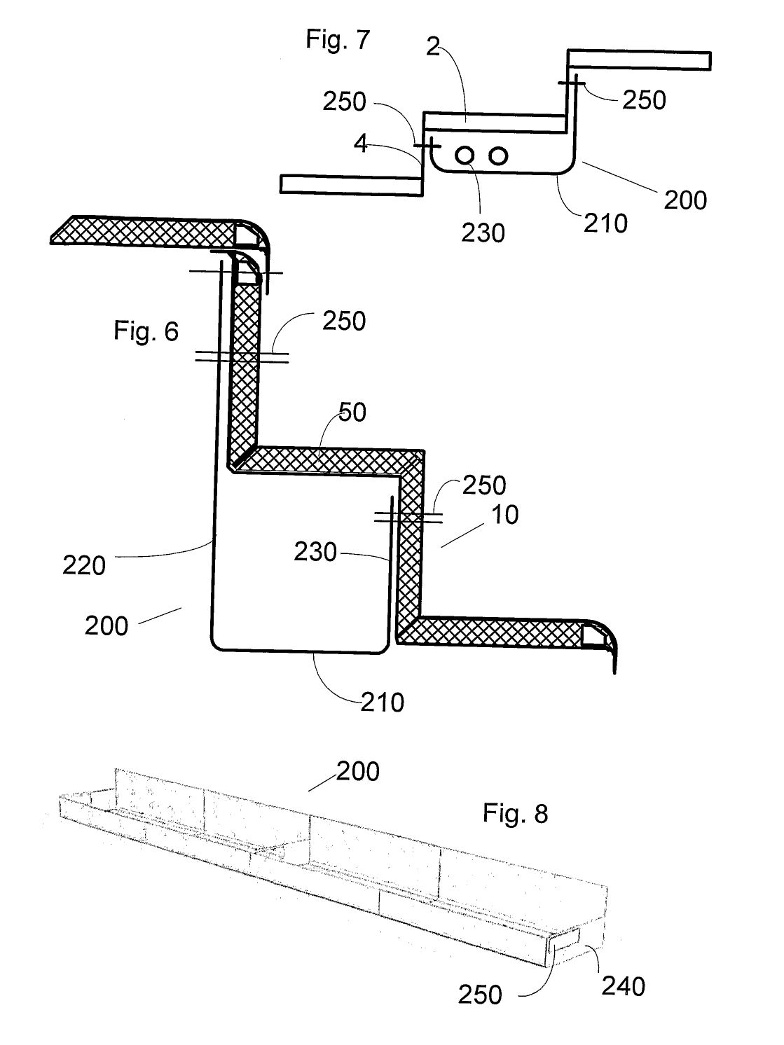

FIG. 6 illustrates a member for changing the mechanical dynamic performance of a stepped riser attached to the stepped riser of FIG. 4;

FIG. 7 illustrates a member for changing mechanical dynamic performance of a stepped riser attached to a different type of stepped riser; and

FIG. 8 is a perspective view of a member for changing mechanical dynamic performance of a stepped riser.

FIG. 1 shows a portion of a sports stadium which typically has a width W of between 10 and 15 metres and is supported at each end by raker beams 5 which can cantilever over other parts of the stadium. The risers on which seats 9 are placed are comprised of run portions 2 which are generally horizontal and rise portions 4 which are generally vertical. The stepped riser is attached to the raker beams 5 with a series of brackets 8.

The riser is formed from a plurality of elements comprised of a sheet of metal and a layer of plastics or polymer material bonded to the sheet of metal. That element is bent, optionally on site, into the shape of a stepped riser. One or several of the stepped risers can then be attached to the raker beams 5 to form a seating section of, for example, a stadium. However, other uses of the stepped risers are also possible.

FIG. 2 shows a first sheet of metal 10 for forming into an element 25 which can be bent into a stepped riser. An element 25 as illustrated in FIG. 3 is formed by bonding a layer 50 of plastics or polymer material to the sheet of metal 10 before bending the element 25 to form a stepped riser with at least one run portion 2 and at least one riser portion 4 as illustrated in FIG. 4.

Some preparation of the sheet of metal 10 is made prior to bonding such that when the layer 50 of plastics or polymer material is bonded to the sheet 10 it is possible to arrange for the layer to have at least one indentation 46,48 which then allows, after bonding, bending of the sheet of metal along at least one predetermined line without compression or tensile forces being induced through the thickness of the layer of plastics or polymer material. This is described in more detail below.

In the sheet 10 of FIG. 2, there are four portions 11, 12, 13, 14 which will form rise portions 11, 13 and run portions 12, 14 of the stepped riser. The exact number and proportional length of those portions 11, 12, 13, 14 can be varied according to the desired dimensions and shape of the stepped riser. For example, all of the rise portions need not be the same height so that a curved stepped riser can be created.

Between each of the portions 11, 12, 13 and 14 measures are taken to ensure that when a layer of plastics or polymer material is bonded to the underside of the metal sheet 10 indentations 46, 48 are present in the layer of plastics or polymer material. These indentations 46, 48 are provided along pre-determined lines between portions 11, 12, 13 and 14 along which the sheet 10 is to be bent to form the rise and run portions of the stepped riser.

The indentations 46,48 are arranged to be on the side of the layer towards which portions on either side of the indentation are to be bent. Thus, in the case where upper surfaces of portions 11 and 12 are to be bent towards each other the indentation 46 in the layer of plastics or polymer material is provided on the side of that layer bonded to the sheet of metal 10. Alternatively, where the sheet of metal 10 is to be bent such that the side of the sheet of metal on which the plastics or polymer layer 50 is present are to be brought together, the indentation 48 in the plastics or polymer layer is provided in a side opposite to the side of the sheet of metal 10. Perimeter bars 26 are placed at each end of the sheet of metal 10 along what will be the longitudinal edges. A second metal layer or layers 180 can also be provided at this time. A seal weld is made at the longitudinal edges between the sheet of metal and the second metal layer.

In the case of pre-determined lines along which the sheet of metal 10 is to be bent so that its top surface comes closer together substantially to form a right angle, a protrusion 20 is formed in the sheet of metal 10. The protrusion 20 is formed along at least one of the pre-determined lines along which the sheet 10 is to be bent and on the underside of the sheet 10. Then when the layer of plastics or polymer material is bonded to the underside of the sheet 10 an indentation 46 will be present at the location of the protrusion 20.

Preferably the protrusion 20 is formed by pre-bending the sheet 10 so that the thickness of the sheet 10 is constant throughout its length and such that no material needs to be added to the sheet. In this case, it is possible to form the protrusion 20 by rolling the sheet of metal 10. This way of forming the protrusion ensures that there is no limitation to the length of the element. Preferably the pre-bend is, in cross-section, substantially a V shape in which the sides of the V meet each other at least 90°, preferably at substantially 94°. In this way by bending the sheet of metal so that it bends at the bottom of the groove formed by the V, the sheet of metal may be bent through substantially 90° to form a rise portion 4 and a run portion 2 as will be described below.

In the case of bending the element 25 in the opposite direction, for example between portions 12 and 13, a former 45 is provided on the sheet of metal 10 prior to casting of the plastics or polymer material to ensure that an indentation 48 is formed along the pre-determined line between portions 12 and 13 on the side opposite the sheet of metal 10. The former 45 may be made of metal or plastic for example and can either be removed after casting or can be left in place.

Non-stick tapes 40 are positioned on the sheet of metal 10 prior to casting of the plastics or polymer layer at locations at which indentations 46,48 will be formed in the layer 50 of plastics or polymer material during casting. Preferably this non-stick tape 40 is Teflon® but other alternatives may be available. The function of the non-stick tape 40 is to ensure that there is no bond between the layer 50 of plastics or polymer material and the sheet 10 along the pre-determined lines along which the sheet of metal 10 will be bent. This can be arranged for either by ensuring that there is no bond between the tape and the sheet of metal and/or between the tape 40 and the layer 50 of plastics or polymer material. Thus, slippage between the layer 50 of plastics or polymer material and the sheet of metal 10 will be possible at the location of the pre-determined lines so that on bending along the pre-determined lines the layer 50 of plastics or polymer material in close proximity to the pre-determined line will remain bonded to the sheet 10 and will not be pulled off by forces generated in the layer.

It is preferable that the plastics or polymer material is bonded onto the sheet of metal 10 by casting, though this is not necessarily the case.

In the case of casting the transverse edges 30 of the sheet of metal 10 are bent at substantially 90° to the remainder of the sheet 10. This helps in final assembly as well as during casting of the plastics or polymer material. A mould is created by blocking the ends of the sheet 10 between the sheet 10 and the two upturned transverse edges 30 with foam end blocks of a foam material, preferably a dense closed cell foam. When the sheet 10 is turned upside down relative to the illustration in FIG. 2, plastics or polymer material may be cast into the cavity created by the sheet 10, the upturned transverse edges 30 and the foam ends. This casting produces an element 25 as illustrated in FIG. 3 in which a layer of plastics or polymer material 50 comprises indentations 46 formed by protrusions 20 in the sheet of metal and a further indentation 48 formed by former 45. The indentations 46, 48 ensure that there are substantially no compression and/or tension forces through the thickness of the layer along the lines at which the element is to be bent and allow bending because of the missing volume of material along those lines.

As will be appreciated, the element 25 of FIG. 3 can be provided to a site at which a stepped riser is required, in flat form. In this way the elements can be very easily transported. However, it may be that the elements are bent to form a stepped riser away from the site. A simple way of bending the element 25 along the predetermined lines is by using rollers.

When the element 25 of FIG. 3 is bent along the pre-determined lines which are at the locations of the indentations 46 and 48, a stepped riser as illustrated in FIG. 4 is produced. Thus, portions 11 and 13 become rise portions and portions 12 and 14 become run portions. Clearly the element 25 may be made up of any number of portions 11, 12, 13, 14 to form rise and run portions.

At the site of the protrusions 20 which are used to form indentations 46 in the plastics or polymer material layer 50 the folds of material of the sheet of metal may leave a gap which is preferably sealed. The sealing can be done by a bead of welding 70 or a different type of sealant can be used. The same may be done at the site of the indentations.

A second sheet of metal 180 may be attached to the side of the layer 50 of plastics or polymer material 50 opposite to that of the first metal sheet 10. This is an optional feature and the second metal layer 180 can be adhered or otherwise bonded to the layer of plastics or polymer material 50 or can be bolted or welded etc. to the upper layer at locations of the transverse portions 30. In FIG. 4 bolts 185 through the transverse edge portions 30 are illustrated.

Perimeter bars can be welded to the transverse edge 30 to join the first plate 10 to the second plate 20.

FIG. 5 shows how a plurality of elements of FIG. 4 can be joined together to form a larger stepped riser. A joint between neighbouring portions of the stepped riser is illustrated in the centre of FIG. 5 in which it can be seen that the transverse portions 30 extend over a portion of the neighbouring bent element 25 and bolts 110 can be used to join the two portions.

Each of the elements is attached to the raker beams 5 via a bracket 8. Again bolts 120 can be used for this purpose though welding may also be suitable.

The foam end blocks may extend beyond the steel sheet 10 to provide a flexible joint between the ends of adjacent risers. These may either be of a thickness less than the distance between the two sheets of metal or may be T-shaped so that their outer edges align with the outer surfaces of the sheets. In this way the width W of the stand can be increased. Foam of the type used in bridges for expansion joints may be suitable here as these allow for expansion of the stepped riser as required. These joints can also be glued to the metal sheet 10 (and sheet 180) and to an adjacent end block to provide a watertight seal between the riser sections. In some cases the foam end blocks may be located just inside the end of the steel plates. Steel end caps can then be welded at both ends of the element 25 to completely enclose and seal the plastics or polymer layer 50.

Hand rails, stairs, seats and other attachments can be added to the stepped riser after assembly onto the raker beams 5.

The dynamic performance of the stepped riser of FIG. 5 may not be as desired. For this purpose a member 200 for changing the mechanical dynamic performance of the riser is provided. The member 200 comprises a sheet of material (e.g. steel) with transverse edge portions 220, 230 which are bent to one side of the sheet. The first transverse edge portion 220 is longer than the second transverse edge portion 230 so that the first transverse edge portion 220 can be attached to a rise portion 4 positioned above a run portion 2 which is itself positioned above a second rise portion 4 to which the second transverse portion 230 is attached. The faces of the transverse edge portions 220, 230 abut with the faces of the riser portions 4 and they may be attached by welding or preferably using bolts 250 as illustrated.

The member 200 can be attached to any two rise portions 4 either portions which are part of the same element 25 or to portions of adjacent elements 25. The number of members 200 used depends on the design and they can be regularly spaced or, preferably, spaced irregularly.

The member 200 for changing mechanical dynamic performance of a stepped riser can be used on any type of stepped riser. FIG. 7 illustrates a different embodiment in which the rise portions 4 are formed solely by a sheet of metal whereas the run portions 2 are formed of a sheet of plastics or polymer material sandwiched between two metal layers. Utilities can be provided through the gap between the member 200 and the run portion 2 through conduits 230 supported by the middle part 210 of the sheet of member 200.

FIG. 8 illustrates a member 200 for changing the mechanical dynamic performance of stepped riser in perspective view. As can be seen, plates 240 may be provided at the ends of the members 200 and at intermediate positions along the width of the member 200 to divide the hollow space defined between the member 200 and the run portion 2 into one or more parts. Inspection hatches 245 may be provided.

### Materials

The sheets of metal 10, 180, and other metal parts of the riser section described above, are preferably made of structural steel, as mentioned above, though these may also be made with aluminium, stainless steel, galvanised steel or other structural alloys in applications where lightness, corrosion resistance or other specific properties are essential. The metal should preferably have a minimum yield strength of 240 MPa and an elongation of at least 10%.

The plastics or polymer material should have, once cured, a modulus of elasticity, E, of at least 250 MPa, preferably 275 MPa, at the maximum expected temperature in the environment in which the member is to be used. In civil applications this may be as high as 100° C.

The ductility of the plastics or polymer material at the lowest operating temperature must be greater than that of the metal layers, which is about 20%. A preferred value for the ductility of the core material at lowest operating temperature is 50%. The thermal coefficient of the core material must also be sufficiently close to that of the steel so that temperature variation across the expected operating range, and during welding, does not cause delamination. The extent by which the thermal coefficients of the two materials can differ will depend in part on the elasticity of the core material but it is believed that the thermal expansion coefficient of the core material may be about 10 times that of the metal layers. The coefficient of thermal expansion may be controlled by the addition of fillers.

The bond strength between the core and metal layers must be at least 0.5, preferably 6, MPa over the entire operating range. This is preferably achieved by the inherent adhesiveness of the core material to metal but additional bond agents may be provided.

The core material is preferably a polyurethane elastomer and may essentially comprise a polyol (e.g. polyester or polyether) together with an isocyanate or a di-isocyanate, a chain extender and a filler. The filler is provided, as necessary, to reduce the thermal coefficient of the intermediate layer, reduce its cost and otherwise control the physical properties of the elastomer. Further additives, e.g. to alter mechanical properties or other characteristics (e.g. adhesion and water or oil resistance), and fire retardants may also be included.

Whilst an embodiment of the invention has been described above, it should be appreciated that this is illustrative and not intended to be limitative of the scope of the invention, as defined in the appended claims. In particular, the dimensions given are intended as guides and not to be prescriptive. Also, the present invention has been exemplified by description of a seating riser but it will be appreciated that the present invention is applicable to other forms of stepped structure.

1-41. (canceled)

42. A method of manufacturing a stepped structure, said method comprising:
providing a first sheet of metal;
bonding a layer of plastics or polymer material to said first sheet of metal; and after said bonding, bending said sheet of metal along at least one predetermined line to form at least one run portion and at least one rise portion.

43. The method of claim 42, wherein said layer of plastics or polymer material has an indentation along an area adjacent to said predetermined line.

44. A method of manufacturing a stepped structure, said method comprising:
providing a first sheet of metal;
preparing for the bonding of a layer of plastics or polymer material to said sheet of metal so that said layer has at least one indentation thereby to allow, after bonding, bending of said sheet of metal along at least one pre-determined line substantially without inducing compression and/or tension through the thickness of said layer of plastics or polymer material.

45. The method of claim 44, further comprising bonding of a layer of plastics or polymer material onto said sheet of metal, wherein at least one indentation is formed in said layer thereby to allow bending of said sheet of metal along pre-determined lines substantially without inducing compression or tension through the thickness of said layer of plastics or polymer material.

46. The method of claim 44, further comprising bending said sheet of metal along said at least one pre-determined line to form at least one run portion of said stepped structure and at least one rise portion of said stepped structure.

47. The method of claim 42, further comprising attaching a second sheet of metal to said stepped structure on a side of said plastics or polymer material opposite to said first sheet of metal.

48. The method of claim 43, wherein said first sheet is prepared by pre-bending said sheet of metal to form protrusions along said at least one pre-determined line on one side for creating said indentation when said plastics or polymer material is bonded onto said sheet of metal.

49. The method of claim 47, wherein said pre-bend is, in cross-section, substantially V-shaped.

50. The method of claim 47, wherein said pre-bend is applied during rolling of said sheet.

51. The method of claim 43, wherein said at least one indentation is, in cross-section, substantially V or U-shaped.

52. The method of claim 43, wherein said sheet is prepared for bonding by applying a non-stick tape to said sheet along said at least one pre-determined line such that said non-stick tape will be positioned between said sheet of metal and said layer of plastics or polymer material and such that said plastics or polymer material will not bond to said non-stick tape and/or said non-stick tape does not bond to said sheet of metal.

53. The method of claim 43, wherein said first sheet is prepared for bonding by providing a former for creating said indentation when said plastics or polymer material is bonded onto said sheet of metal.

54. The method of claim 42, wherein said bonding comprises casting.

55. The method of claim 42, further comprising providing a further sheet of metal and joining said first and second sheets of metal to form a stepped structure with each sheet comprising at least one run portion and at least one rise portion.

56. The method of claim 42, further comprising sealing any voids formed between said rise portion and said run portion during said bending.

57. The method of claim 56, wherein said sealing comprises welding.

58. The method of claim 42, wherein sheet of metal is bent at opposing transverse edges of said sheet to form a U-shaped cross-section.

59. The method of claim 58, further including blocking the other edges of said sheet with a foam end block to form a recess into which said plastics or polymer material can be cast.

60. The method of claim 59, wherein two sheets of metal are attached through said foam end block thereby to provide and expansion joint.

61. A stepped structure comprising an element for forming into a stepped structure, said element comprising a sheet of metal and a layer of plastics or polymer material bonded to said sheet of metal, said layer comprising at least one indentation thereby to allow bending of said sheet of metal along at least one pre-determined line substantially without inducing compression and/or tension through the thickness of said layer, wherein said element is bent along said at least one pre-determined line to form at least one run portion and at least one rise portion.

62. The stepped structure of claim 61, wherein a protrusion formed in said sheet by a bend or bends in said sheet along said at least one pre-determined line is positioned in said at least one indentation.

63. The stepped structure of claim 61, wherein said protrusion is V-shaped in cross-section.

64. The stepped structure of claim 61, further comprising non-stick tape positioned between said sheet of metal and said layer of plastics or polymer material along said at least one pre-determined line such that said plastics or polymer material is not bonded to said non-stick tape and/or said non-stick tape is not bonded to said sheet of metal.

65. The stepped structure of claim 61, wherein said sheet of metal has opposed transverse edges bent towards said layer of plastics or polymer material.

66. The stepped structure of claim 61, further comprising foam end members positioned on said sheet of metal adjacent longitudinal edges, next to said layer of plastics or polymer material.

67. The stepped structure of claim 61, wherein voids formed between said at least one rise portion and said at least one run portion are sealed.

68. The stepped structure of claim 61, further comprising a second sheet of metal attached to said riser on a side of said plastics or polymer material opposite said first sheet of metal.

69. The stepped structure of claim 61, further comprising a further element for forming into a stepped structure, said element comprising a sheet of metal and a layer of plastics or polymer material bonded to said sheet of metal, said layer comprising at least one indentation thereby to allow bending of said sheet of metal along at least one pre-determined line substantially without inducing compression and/or tension through the thickness of said layer, wherein said further element is bent along said at least one pre-determined line to form at least one run portion and at least one rise portion and said two elements are attached to one another.

70. A spectator stand having at least one stepped structure according to claim 61.

71. A stepped structure comprising a run portion and two rise portions, one either side of said run portion, and a member for changing the mechanical dynamic performance of the stepped structure, said member comprising a sheet of material with transverse edge portions which are portions of each transverse edge bent to one side of said sheet, one of said transverse edge portions being longer than the other, wherein one of said transverse edge portions is fastened to a first rise portion and the other of said transverse edge portions is attached to the other rise portion on the other side of the run portion.

72. The stepped structure of claim 71, wherein at least one of said member, said run portion and said rise portion are comprised of a layer of plastics or polymer material sandwiched between outer metal layers.

73. The stepped structure of claim 71, wherein said riser portions and said longitudinal edge portions abut face to face.

74. The stepped structure of claim 71, wherein said riser portions are bolted to said longitudinal edge portions.

75. The stepped structure of claim 71, wherein conduits run in the space between said element and said run portion.
